(19) United States
(12) Patent Application Publication
(10) Pub. No.: US 2023/0418853 A1
(43) Pub. Date: Dec. 28, 2023

(54) CONTROLLING MULTIPLE DIGITAL CHARACTERS IN AN INTERACTIVE AUDIO EXPERIENCE

(71) Applicants: Amy L. Stapleton, Stuart, FL (US); Wayne A. Richard, Loudonville, NY (US)

(72) Inventors: Amy L. Stapleton, Stuart, FL (US); Wayne A. Richard, Loudonville, NY (US)

(21) Appl. No.: 18/209,472

(22) Filed: Jun. 13, 2023

Related U.S. Application Data
(60) Provisional application No. 63/354,240, filed on Jun. 22, 2022.

(51) Int. Cl. G06F 16/332; G10L 13/08

(52) U.S. Cl. CPC G06F 16/3329; G10L 13/08

(57) ABSTRACT

A method of presenting an interactive audio experience to a human user is disclosed. Engagement of multiple digital characters with the user is controlled during a simulated group conversation that mimics a real-life group interaction. Dialog for each digital character to speak in a simulated scene of a storytelling script is developed. The storytelling script includes one or more blocks of script and specifies which digital character is speaking. A pre-generated question is posed to a user from one of the digital characters as part of the dialog. A pre-generated response from the digital character to the user is selected based on an analysis result of the answer from the user. Each block of script is marked to indicate the type of dialog from a predetermined list of dialog types.

### CROSS-REFERENCE TO RELATED APPLICATIONS

This application claims priority to U.S. Provisional Application Ser. No. 63/354,240, filed Jun. 22, 2022, titled “CONTROLLING MULTIPLE DIGITAL CHARACTERS IN AN INTERACTIVE AUDIO EXPERIENCE”, hereby incorporated by reference in its entirety for all of its teachings.

### TECHNICAL FIELD

This invention relates to interactive audio experiences. More specifically, this invention relates to presenting an interactive audio experience where multiple conversational agents engage a human user in a series of simulated conversations and interactive skits.

### BACKGROUND OF THE INVENTION

### Problem

The U.S. population recently experienced a time of unprecedented social isolation because of the COVID-19 lockdowns. Adults in the U.S. over 50 years of age were especially hard hit. In data captured in August of 2020, 64% of U.S. women and 57% of U.S. men 50 and older reported experiencing feelings of social isolation.

The social shock caused by the lockdowns exacerbated a problem already present in our society. As people age, they have fewer outlets for social interactions.

Even before the lockdowns studies showed a strong correlation between isolation and loneliness and mental and physical decline. As the lockdowns subside, we are left with a heightened awareness of the importance of social interactions and how fragile our aging population is without them.

### Current Technology

Interactive voice technology sprang into the global consciousness with the release of Apple's Siri voice assistant in 2007. Amazon took another step towards making voice control and conversational AI prevalent in our lives by bringing their Amazon Echo smart speaker to market in 2015.

Data published by Voicebot.ai shows that in July of 2019, over 20% of U.S. households with residents 60 and over had a smart speaker. Another report by Parks Associates suggests that number could have grown to as much as 40% by 2021.

Older adults clearly see benefits in interactive voice technologies. High on the list of uses are the ability to:
Easily initiate or receive voice or video calls from family and friends
Request favorite music
Set timers and reminders
Control smart home devices, such as smart lights

During the COVID lockdowns, staff at senior living facilities and the adult children of isolated loved ones rushed to get smart speakers to those who were cut off from society. Amazon Alexa's drop-in feature made it easy for family members to connect with their loved ones. Smart speakers and smart displays became a crucial lifeline to the outside world.

As wonderful as it is to connect with family via a smart display, these interactions tend to be brief. Older adults who have diminished social connections lack the opportunity to engage in daily conversation. The aging senior is still forced to navigate many hours alone in their room.

Current digital voice assistants provide responses to voice queries and execution of voice commands. Advanced voice assistants are capable of open domain conversation across a limited range of topics. Neither of these inventions address an isolated adult's need to be part of a social setting with vivid conversations including more than one participant. What is needed is a group of digital characters that mimic a social setting and offer conversational interactions with the user.

### SUMMARY OF THE INVENTION

In accordance with one embodiment of the present invention, a method of presenting an interactive audio experience to a user by controlling engagement of multiple digital characters with the user during a simulated group conversation that mimics a real-life group interaction is disclosed. The method includes developing dialog for each digital character to speak in a simulated scene of a storytelling script. The storytelling script includes one or more blocks of script and specifies which digital character is speaking. The method also includes posing, to a user, a pre-generated question from one of the digital characters as part of the dialog. The method further includes selecting, based on an analysis result of the answer from the user, a pre-generated response from the digital character to the user. Each block of script is marked to indicate the type of dialog from a predetermined list of dialog types. The method also includes a controller that communicates with a Natural Language Processing (NLP) system integrated into a smart speaker platform and instructs the platform on when to speak dialog from the script, when to open the mic to receive the user's response, and how to interpret the user's response.

The dialog type may comprise at least one of the following: dialog with no question for the user; question awaiting a Yes or No response from the user; question awaiting a pre-defined binary response from the user other than Yes or No; question awaiting any response from the user; or end of episode or story.

In some embodiments, the method includes retaining or storing user answers/responses in memory and/or a database for later referencing in the same story or future stories.

The dialog scripts or storytelling script may be stored in a database.

In some embodiments, the digital characters speak using synthetic voices based on text-to-speech conversion.

In some embodiments, the script does not change regardless of the answer/response of the user to a question from the digital character.

The script may be developed using a scripting tool and specifies at least the following: which digital character should be speaking; when dialog hand-offs should occur from one virtual character to another; which digital character should ask the user a question; what response from the digital character should be provided based on the user's spoken input; and which digital character should speak after the user responds to a question and what the response from the digital character should be.

In some embodiments, the interactive audio experience between the multiple digital characters and user engaging in the simulated group conversation is implemented as an app on any smart speaker device.

In another embodiment of the present invention, a system for presenting an interactive audio experience to a user by controlling engagement of multiple digital characters with the user during a simulated group conversation that mimics a real-life group interaction is disclosed. The system includes a scripting editor for developing dialog for each digital character to speak in a simulated scene of a storytelling script, wherein each block of script specifies which digital character is speaking. The system also includes a controller that instructs an underlying smart speaker platform's Natural Language Processing system on how to process the dialog script and how to interpret and process the user's statements and responses to questions. The system also includes a controller that instructs the underlying smart speaker platform on when and how a digital character's dialog from the script should be spoken and when to open the mic for user input. The system also includes a speech output converter for converting text from the script to speech. The system further includes a dialog type, where each block of text in the script is marked to indicate to the controller the type of dialog from a predetermined list of dialog types. The system also includes a database for storing the dialog scripts and answers or responses to questions posed from the digital character to the user.

### BRIEF DESCRIPTION OF THE DRAWINGS

FIG. 1 is a flowchart illustration method of presenting an interactive audio experience to a user by controlling engagement of multiple digital characters with the user during a simulated group conversation that mimics a real-life group interaction, in accordance with one embodiment of the present invention.

FIG. 2 is a diagram of a system for presenting an interactive audio experience to a user by controlling engagement of multiple digital characters with the user during a simulated group conversation that mimics a real-life group interaction, in accordance with one embodiment of the present invention.

FIG. 3 depicts aspects of a scripting editor for developing dialog of a storytelling script, in accordance with one embodiment of the present invention.

FIG. 4 depicts aspects of a scripting editor for developing dialog of a storytelling script, in accordance with one embodiment of the present invention.

FIG. 5A depicts aspects of a scripting editor with example story dialog of a storytelling script, in accordance with one embodiment of the present invention.

FIG. 5B depicts aspects of a scripting editor with additional example story dialog to the storytelling script of FIG. 5A, in accordance with one embodiment of the present invention.

FIG. 5C depicts aspects of a scripting editor with an alternative embodiment of the example story dialog to the storytelling script of Figure SA, in accordance with one embodiment of the present invention.

### DETAILED DESCRIPTION OF THE PREFERRED EMBODIMENTS

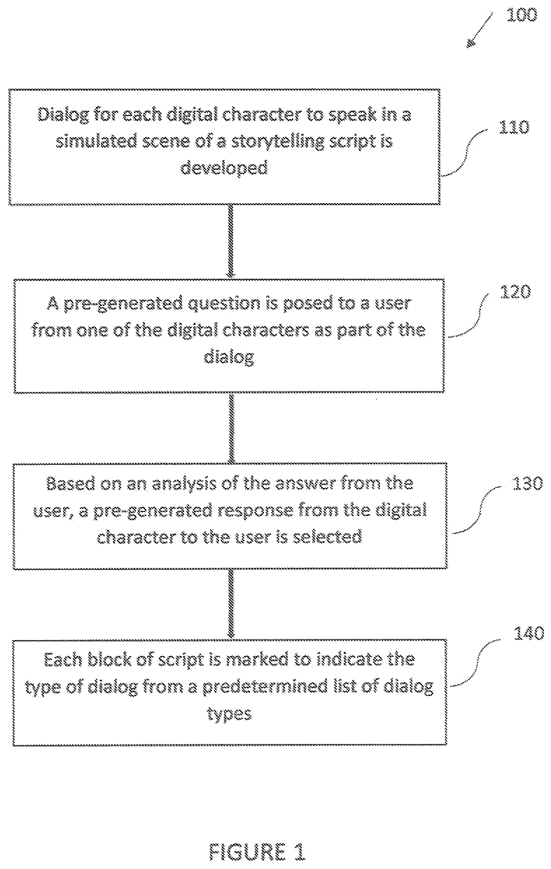

FIG. 1 shows a block diagram of a method 100 of presenting an interactive audio experience to a user by controlling engagement of multiple digital characters with the user during a simulated group conversation that mimics a real-life group interaction, in accordance with one embodiment of the present invention. The interactive audio experience between the multiple digital characters and user engaging in the simulated group conversation may be implemented as an app on any smart speaker device such as, but not limited to, Amazon Echo Dot, Google Mini, and Apple HomePod Mini. In 110, dialog for each digital character to speak in a simulated scene of a storytelling script is developed. The script specifies which digital character is speaking and, in certain embodiments, does not change regardless of the answer/response of the user to a question from the digital character. The script may be developed using a scripting tool and stored in a database. The script specifies at least the following: which digital character should be speaking, when dialog hand-offs should occur from one virtual character to another, which digital character should ask the user a question, what response should be provided from the digital character based on the user's spoken input, and which digital character should speak after the user responds to a question and what the response from the digital character should be. Also, user answers/responses to questions may be stored in memory and/or a database for later referencing in the same story or future stories.

In 120, a pre-generated question is posed to a user from one of the digital characters as part of the dialog. The questions may be inserted anywhere in the story to engage the user/listener with conversation. In some embodiments, the digital character remembers how the user answered certain questions, then later, either in the same episode or in future episodes, refers back to what the user said previously and acknowledge what was said and use that going forward. The digital characters use synthetic voices that are based on text to speech technology.

In 130, a pre-generated response from the digital character to the user is selected based on an analysis of the answer from the user. As mentioned above, the responses or answers from the user may be used later by the digital character to recount aspects of an earlier part of the conversation. As one example, the script describes a story where the digital character is on a train, going to London, and the user/listener is sitting next to the character on the train as the digital character is telling their life story on the way to London. In the first episode, the digital character may ask the user: “Have you ever been to London?” Then based on the way the user responded to that, much later in the story, in say the third episode, as the train is pulling into the station in London, the digital character says: “Hey, I remember you said you'd never been to London before, so here's a couple of places I think you'd really enjoy visiting.” If the user responds that she had been to London, then the digital character might say: “I know you said you've been to London before, and there's this museum that has some new exhibits and I think you might really like to visit that.” The fact that the digital character recalls what the user said in an earlier episode and acknowledges that they have remembered that and that it was meaningful to them, and they use that again in the story, it can be really effective in creating an engaging storytelling experience.

In 140, each block of script is marked to indicate the type of dialog from a predetermined list of dialog types. The dialog type may comprise at least one of the following: dialog with no question for the user; question awaiting a Yes or No response from the user; question awaiting a pre-defined binary response from the user other than Yes or No; question awaiting any response from the user; or end of episode or story.

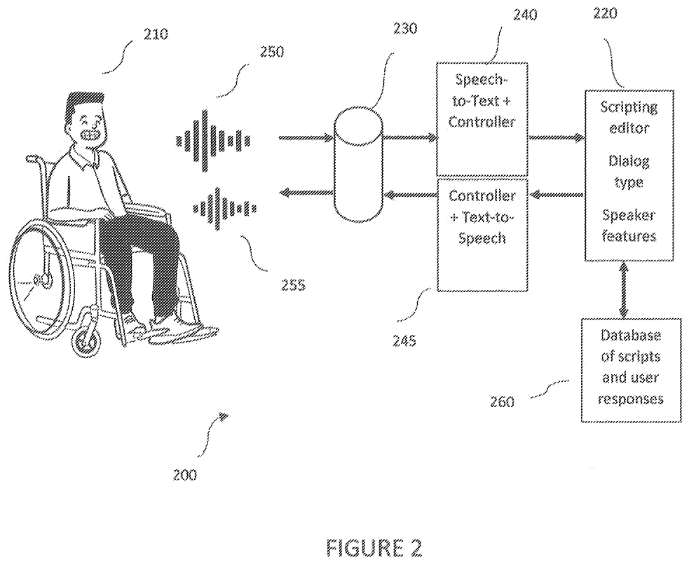

FIG. 2 is a diagram of a system 200 for presenting an interactive audio experience to a user 210 by controlling engagement of multiple digital characters (not shown) with the user 210 during a simulated group conversation that mimics a real-life group interaction. The system 200 includes a scripting editor 220 for developing dialog for each digital character to speak in a simulated scene of a storytelling script, wherein the script specifies which digital character is speaking. Features of each speaker, such as voice and tone, are included in the scripting editor 220. The system 200 also includes a controller and speech output converter 245 for converting text from the script to speech 255 and providing handling instructions to the smart speaker platform 230 to indicate a flow of speech or an opening of the microphone to receive user input. The scripting editor 220 further includes a dialog type, where each block of text in the script is marked to indicate to the controller and speech output converter 245 the type of dialog from a predetermined list of dialog types. The system also includes a database 260 for storing the dialog scripts and spoken responses 250 to questions posed from the digital character to the user 210, which undergoes a speech-to text 240 conversion before being saved in the scripting editor 220 and stored in the database 260.

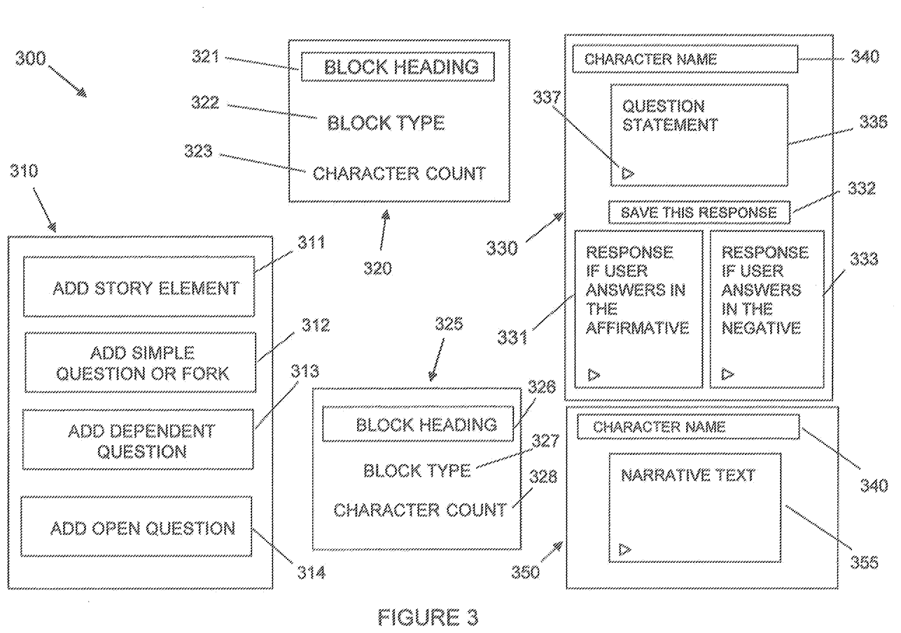

FIG. 3 depicts aspects of a scripting editor 300 for developing dialog of a storytelling script, in accordance with one embodiment of the present invention. The script includes content for a story that is read aloud by the digital character(s) to a user or listener and specifies, among other things, which digital character should be speaking; when dialog hand-offs should occur from one digital character to another; which digital character should ask the user a question; what response from the digital character should be provided based on the user's or listener's spoken input; and which digital character should speak after the user or listener responds to a question and what the response from the digital character should be.

The scripting editor 300 includes an element bar 310, a first story block pane 320, a second story block pane 325, a first conversational block 330 associated with the first story block pane 320, and a second conversational block 350 associated with the second story block pane 325. It should be noted that the scripting editor 300 may include any number of conversational blocks, each with its own story block pane. For example, if the script includes, say, 75 conversational blocks, then the script will have 75 story block panes as well. If the script includes 57 story block panes, the script will also have 57 conversational blocks.

The element bar 310 consists of a list of dialog types for developing dialog for each digital character to speak in a simulated scene of the storytelling script. The dialog types include: “ADD STORY ELEMENT” 311, “ADD SIMPLE QUESTION OR FORK” 312, “ADD DEPENDENT QUESTION” 313, and “ADD OPEN QUESTION” 314.

The “ADD STORY ELEMENT” 311 is used to enter narrative content into a conversational block for one of the virtual characters to speak. This type of dialog poses no question for the user (or listener). The other three dialog types are questions posed to a user from one of the digital characters as part of the dialog.

The “ADD SIMPLE QUESTION OR FORK” 312 is used to have the digital character ask the user a question that can be answered with a simple Yes or No response—or something equivalent—from the user. If the scripting editor is unable to understand the user's response, the digital character will repeat the question until the response is understood. This block type can also be used to create a fork, which are two potential, different statements from the digital character. The block type references how the user responded to a previous Yes or No question and selects one of the two statements in the fork based on how the user answered that question.

The “ADD DEPENDENT QUESTION” 313 type is used to pose a new question based on how the user responded to a previous question—either right away or later in the story.

The “ADD OPEN QUESTION” 314 is a type of question asked by the digital character such that the user's answer does not matter. The open question 314 gives the user more latitude in how they can respond and may be followed with a simple yes or no question to double-check or confirm the user's response.

The story block panes 320 and 325 each include a block heading 321, a block type 322, and a character count 323. It should be noted that first story block pane 320 and second story block pane 325 are the same; however, different reference numbers have been used to designate the panes in FIG. 3 to avoid any confusion. The block heading 321 is the name of a particular or associated conversational block. For example, if a writer wans the digital character to ask the user a question about dogs in conversational block 330, the title could be “dog owner?”. The words “dog owner?” would then replace “BLOCK HEADING” 321 in story block pane 320.

The block type 322 is the dialog type described above—“ADD STORY ELEMENT” 311, “ADD SIMPLE QUESTION OR FORK” 312, “ADD DEPENDENT QUESTION” 313, and “ADD OPEN QUESTION” 314. When a particular dialog type is selected, such as “ADD STORY ELEMENT” 311, the word “story” would appear in place of “BLOCK TYPE” 322 in story block pane 320.

The character count 323 tracks the number of characters entered into a conversational block. For example, if a writer types 45 characters into first conversational block 330, the words “45 characters” would appear in place of“character count” 323 in story block pane 320. In some embodiments, there is a limit to the number of characters entered before the conversational block changes to a darker color. This is done to keep the story moving and allow the user a chance to say something at least every couple of minutes. In one specific embodiment, the story element block will turn a reddish burnt coffee color. In some embodiments, the editor may require a question after 2-3 minutes of uninterrupted spoken content by the digital character.

The conversational blocks 330 and 350 are where the conversational stories or story content are written. The first conversational block 330 appears after the dialog type is selected. In the example shown in FIG. 3, one of the question types 312, 313, 314 is selected. The conversational block 330 includes a character name block 340, a story content block 335, a “SAVE THIS RESPONSE” 332 option to store the user's response in memory for later reference, and response blocks 331 and 333.

The character name block 340 features a dropdown where one of several digital characters may be selected. A different character may be selected for every conversational block in an episode. Whenever a digital character is not selected, a default speaker will be used. These digital characters will have names such as: Alex, Maddison, Lily, and Collin.

The digital characters speak using synthetic voices based on text-to-speech conversion. The text to be converted to speech is the content entered into story content blocks and response blocks, discussed in further detail below.

The story content block 335 and, depending on the dialog type selected, the response blocks 331 and 333 are where the story is created. Narrative content or a question is entered in story content block 335 for the virtual character to speak. A play button 337 appears at the bottom left corner of each content block 335 and response blocks 331 and 333 to allow a writer/author to listen to how the text will sound when spoken in the synthetic voice of the chosen digital character.

In the example shown in FIG. 3, a question dialog type is selected, prompting the writer to enter a question statement in story content block 335. The digital character will ask the user a question that can be answered with a simple affirmative or negative response. The writer has chosen not to save the user's response, with the “SAVE THIS RESPONSE” 332 function still being available and unused.

The conversational block 330 offers two response blocks 331 and 333 for entering responses based on the user's answer to the question. Response block 331 on the left is used for entering the digital character's response in the event the user answers in the affirmative—such as but not limited to “yes”, “I sure have”, or “absolutely”. Response block 333 on the right is used for entering the digital character's response in the event the user answers in the negative—such as but not limited“no”, “I do not”, or “negative”.

After the first conversational block 330 is completed, the next conversational block may be created by selecting a dialog type from the element bar 310. In the example of FIG. 3, story element 311 was selected as the dialog type and the words “narrative text” appear in story content block 355 of second conversational block 350. This prompts the writer to enter narrative text in story content block 355. Also, as in first conversational block 330, the writer would select a digital character from character name block 340 of second conversational block 350. A play button appears at the bottom left corner of story content block 355 to allow the writer/author to listen to how the text will sound when spoken in the synthetic voice of the chosen digital character.

To the immediate left of second conversational block 350, in story block pane 325, the writer can give the conversational block a name in place of “BLOCK HEADING” 326. “BLOCK TYPE” 327, similar to “BLOCK TYPE” 322 above, is the specific dialog type selected by the writer. In the example of FIG. 3, the dialog type “ADD STORY ELEMENT” 311 was selected and would replace the words “BLOCK TYPE” in story block pane 325. “CHARACTER COUNT” 328 has the same purpose as “CHARACTER COUNT 323” described above in connection with story block pane 320, namely, to track the number of characters entered in conversational block 350.

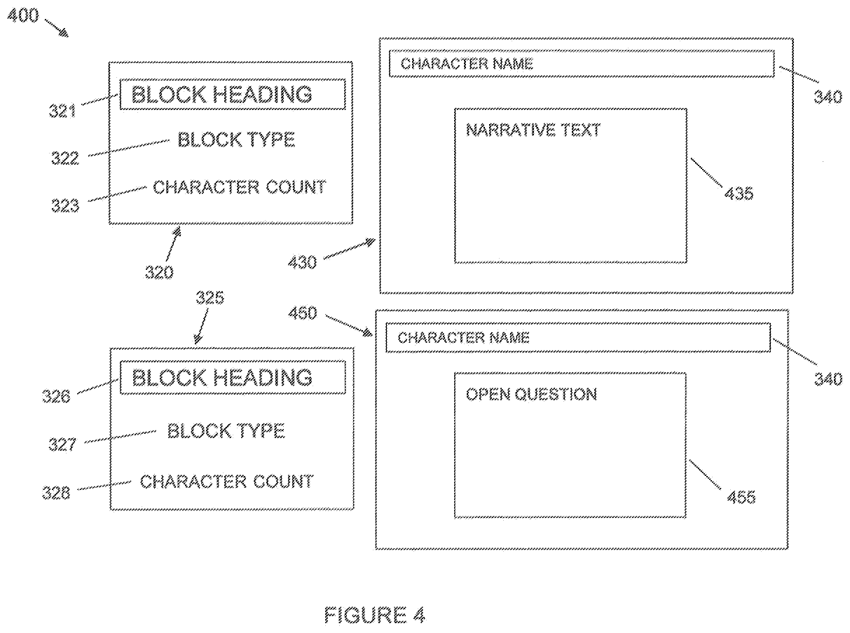

FIG. 4 depicts aspects of a scripting editor 400 for developing dialog of a storytelling script, in accordance with one embodiment of the present invention. The scripting editor 400 is similar to the diagram in FIG. 3, only without the element bar 310 on the left side of the figure. For conversational block 430, the author/writer has selected the dialog type “ADD STORY ELEMENT” 311 (FIG. 3), as reflected in the words “NARRATIVE TEX” in story content block 435 of FIG. 4. Still referring to FIG. 4, on the lower right of the figure, the next conversational block 450, the author/writer has selected the dialog type “ADD OPEN QUESTION” 314 (FIG. 3), as reflected in the words “OPEN QUESTION” in story content block 455 of FIG. 4.

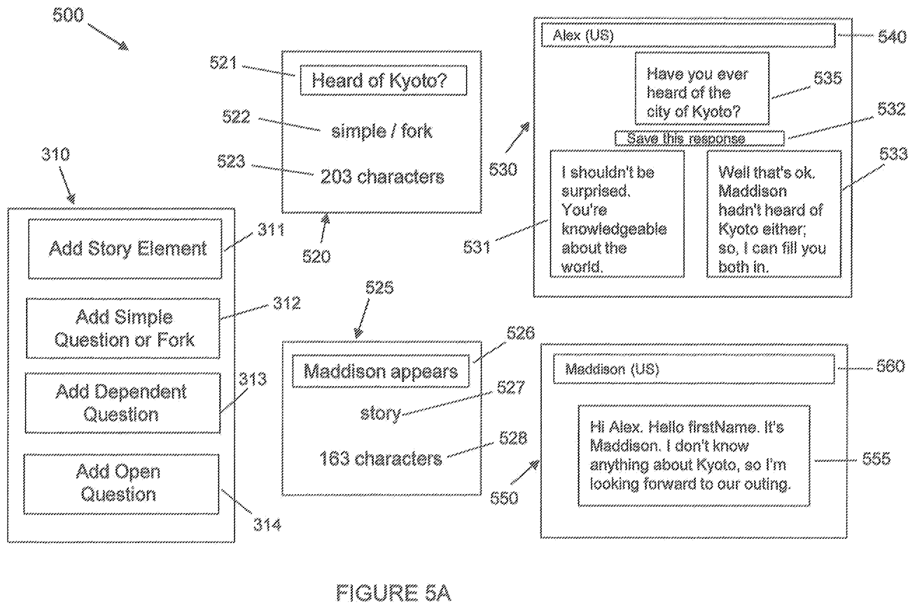

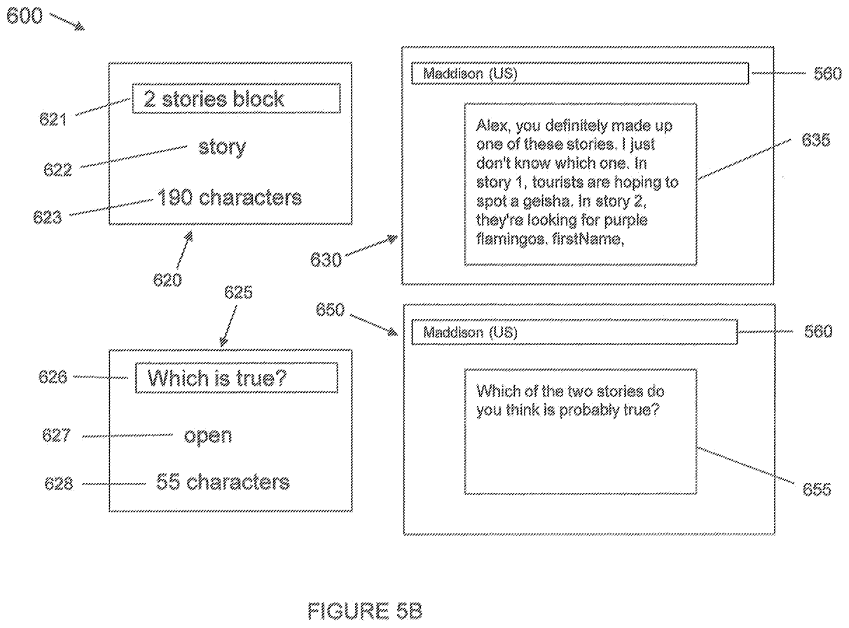

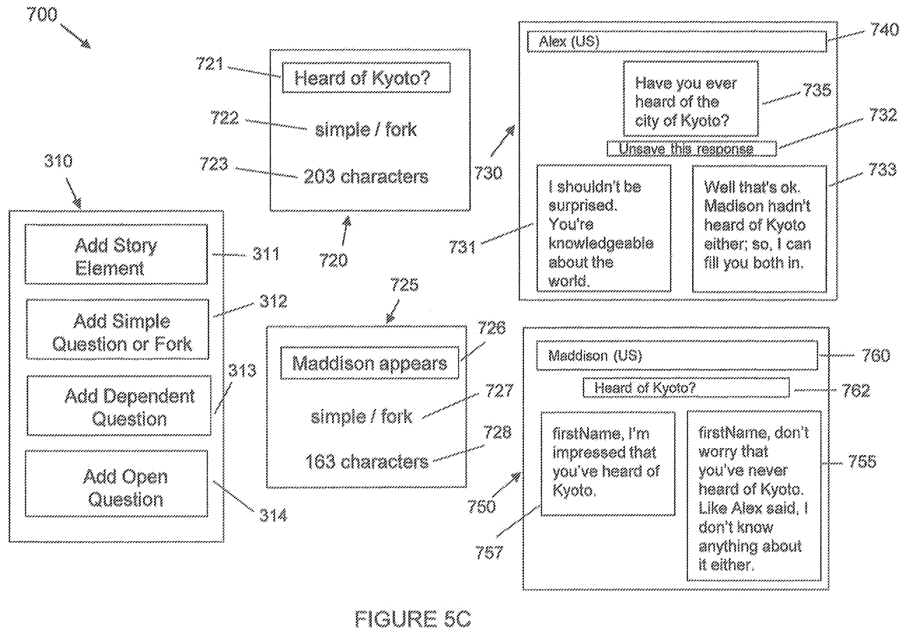

FIG. 5A depicts aspects of a scripting editor 500 with example story dialog of a storytelling script, in accordance with one embodiment of the present invention. FIG. 5A is similar to the diagram in FIG. 3 above. The only difference is the scripting editor 500 is filled with actual story content, written by a writer or author, in conversational blocks, and with actual heading, block type, and character count information in story block panes in the middle of the figure between the element bar and the conversational blocks.

To draft this fictional story about travel and experiences in the city of Kyoto, the writer would first choose a dialog type in element bar 310. The dialog types are the same as in FIG. 3 above, namely, “ADD STORY ELEMENT” 311, “ADD SIMPLE QUESTION OR FORK” 312, “ADD DEPENDENT QUESTION” 313, and “ADD OPEN QUESTION” 314. As shown in story block pane 520, associated with conversational block 530, the writer/author selected “simple/fork” 312 as the block type 522 and named conversational block 530 “Heard of Kyoto?” in block heading 521. Conversational block 530 consists of 203 characters as shown in character count 523. This number represents the total number of characters written within each block—story content block 535, affirmative response block 531, and negative response block 533—contained in conversational block 530.

Still referring to Figure SA, the writer/author has selected the digital character “Alex” in character name block 540 of conversational block 530. The term or abbreviation “(US)” next to “Alex” is used to signify that the digital character “Alex” speaks with a U.S. English accent. Likewise, the term or abbreviation “(UK)” may be used to signify that a digital character speaks with a British English accent.

A simple question requesting a simple “yes” or “no” is entered in story content block 535: “Have you ever heard of the city of Kyoto?”. If the user answers in the affirmative, “yes,” the digital character responds with “I shouldn't be surprised. You're knowledgeable about the world.” in affirmative response block 531. On the other hand, if the user answers in the negative, “no,” the digital character responds with “Well that's ok. Maddison hasn't heard of Kyoto either, so, I can fill you both in” in negative response block 533. The writer has chosen not to save the user's response, with the “SAVE THIS RESPONSE” 532 function still available and unused.

The next story block is written below in FIG. 5A. For conversational block 550, the author/writer has selected dialog type story element 311 from element bar 310. The “story” dialog type appears within story block pane 525 as the block type 527. The author/writer has chosen the name “Maddison appears” as the block heading 526 for conversational block 550. Conversational block also contains a total number of 112 characters, reflected in character count 528 in story block pane 525.

Still referring to FIG. 5A, on the lower right of the figure, the writer/author has selected a different digital character “Maddison” in character name block 560 of conversational block 550. The following narrative is entered in story content block 555: “Hi Alex. Hello firstName, It's Maddison. I don't know anything about Kyoto, so I'm looking forward to our outing.”

The word “firstName” in the preceding paragraph refers to the first name of the user or listener and is used in the storytelling script to indicate when the digital character should speak the user's or listener's first name.

FIG. 5B depicts aspects of a scripting editor 600 with additional example story dialog to the storytelling script of FIG. 5A, in accordance with one embodiment of the present invention. The “ADD STORY ELEMENT” 311 dialog type (FIG. 5A) was chosen, as reflected in story block pane 620 with the word “story” in block type 622 of story block pane 620. The block heading 621 is named “2 stories block”, and conversational block 630 has a total number of 190 characters, reflected in character count 623 in story block pane 620.

Still referring to Figure SB, on the top right of the figure, the writer/author has selected digital character “Maddison” in character name block 560 of conversational block 630. The following narrative is entered in story content block 635: “Alex, you definitely made up one of these stories. I just don't know which one. In story 1, tourists are hoping to spot a geisha. In story 2, they're looking for purple flamingos, firstName.”

The next story block is written below in FIG. 5B. For conversational block 650, the author/writer has selected dialog type “ADD OPEN QUESTION” 314 (FIG. 5A) as reflected in story block pane 625 with the word “open” in the block type 627 section of story block pane 625. The block heading 626 is named “Which is true?”, and conversational block 650 has a total number of 55 characters, reflected in character count 628 in story block pane 625.

Still referring to FIG. 5B, on the bottom right of the figure, the writer/author has selected digital character “Maddison” in character name block 560 of conversational block 650. The following narrative is entered in story content block 655: “Which of the two stories do you think is probably true?”

FIG. 5C depicts aspects of a scripting editor 700 with an alternative embodiment of the example story dialog to the storytelling script of FIG. 5A. Whereas in Figure SA the writer has chosen not to store the user's response to the question asked for later use, in the embodiment shown in FIG. 5C the writer instead chooses to store the user's response and use it in a subsequent statement. As in FIG. 5A, the “ADD SIMPLE QUESTION OR FORK” 312 dialog type was chosen, as reflected in story block pane 720 with the words “simple/fork” in block type 722 of story block pane 720. The block heading 721 is named “Heard of Kyoto?”, and conversational block 730 has a total number of 203 characters, reflected in character count 723 in story block pane 720.

Still referring to FIG. 5C, the writer/author has selected the digital character “Alex” in character name block 740 of conversational block 730. A simple question requesting a simple “yes” or “no” is entered in story content block 735: “Have you ever heard of the city of Kyoto?”. If the user answers in the affirmative, “yes,” the digital character responds with “I shouldn't be surprised. You're knowledgeable about the world” in affirmative response block 731. On the other hand, if the user answers in the negative, “no,” the digital character responds with “Well that's ok. Maddison hasn't heard of Kyoto either; so, I can fill you both in” in negative response block 733. In this embodiment the writer has chosen to save the user's response, as shown in 732 with the “unsave this response” indicating the writer/author has already opted to have the user's response to the question stored.

Still referring to Figure SC, the block following block 730 represents a conversational fork. For conversational block 750, the author/writer has selected dialog type “ADD SIMPLE QUESTION OR FORK” 312 as reflected in story block pane 725 with the words “simple/fork” in block type 727 of story block pane 725. The block heading 726 is named “Maddison appears”, and conversational block 750 has a total number of 163 characters, reflected in character count 728 in story block pane 725. The writer/author has chosen to alter, or fork, the digital character's statement to the user, based upon how the user responded to the “Heard of Kyoto?” question referenced in block 730. Using a drop-down menu shown in content block 762, the writer/author has selected the “Heard of Kyoto?” question, which references the stored memory variable (not shown) containing the user's YES or NO response to the question. If the user responded with “yes” (has heard of Kyoto), Maddison will say “firstName, I'm impressed that you've heard of Kyoto,” as shown in affirmative response block 757. If the user responded with “no” (have not heard of Kyoto), Maddison will instead say, as shown in negative response block 755, “firstName, don't worry that you've never heard of Kyoto. Like Alex said, I don't know anything about it either.” “firstName” indicates that the digital character is to say the first name of the user.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

We claim:

1. A method of presenting an interactive audio experience to a user by controlling engagement of multiple digital characters with the user during a simulated group conversation that mimics a real-life group interaction, comprising:
a. developing dialog for each digital character to speak in a simulated scene of a storytelling script, the storytelling script including one or more blocks of script, wherein each block of script specifies which digital character is speaking;
b. posing, to a user, a pre-generated question from one of the digital characters as part of the dialog; and
c. selecting, based on an analysis result of an answer from the user, a pre-generated response from the digital character to the user;
wherein each block of script is marked to indicate a dialog type from a predetermined list of dialog types.

2. The method of claim 1 wherein the dialog type comprises one of the following:
a. dialog with no question for the user;
b. question awaiting a Yes or No response from the user;
c. question awaiting a pre-defined binary response from the user other than Yes or No;
d. question awaiting any response from the user; and
e. end of episode or story.

3. The method of claim 2 further comprising storing user answers in a database for later referencing in a same story or future stories.

4. The method of claim 3 wherein the storytelling script is stored in a database.

5. The method of claim 4 wherein the digital characters speak using synthetic voices based on text-to-speech conversion.

6. The method of claim 5 wherein the storytelling script does not change regardless of the answer of the user to a question from the digital character.

7. The method of claim 6 wherein the storytelling script is developed using a scripting tool.

8. The method of claim 7 wherein the storytelling script specifies at least the following:
a. which digital character should be speaking;
b. when dialog hand-offs should occur from one digital character to another;
c. which digital character should ask the user a question;
d. what response from the digital character should be provided based on spoken input of the user; and
e. which digital character should speak after the user responds to a question and what the response from the digital character should be.

9. The method of claim 8 wherein the interactive audio experience between the multiple digital characters and the user engaging in the simulated group conversation is implemented as an app on a smart speaker device.

10. A system for presenting an interactive audio experience to a user by controlling engagement of multiple digital characters with the user during a simulated group conversation that mimics a real-life group interaction, comprising:
a. a scripting editor for developing dialog for each digital character to speak in a simulated scene of a storytelling script, the storytelling script including one or more blocks of script, wherein each block of script specifies which digital character is speaking;
b. a controller to instruct an underlying smart speaker platform's Natural Language Processor on: how to process the storytelling script, how to interpret and process the user's statements and responses to questions, when and how a digital character's dialog from the storytelling script should be spoken, and when to open the mic for user input;
c. a speech output converter for converting text from the storytelling script to speech;
d. a dialog type, where each block of script is marked to indicate to the controller the dialog type from a predetermined list of dialog types; and
d. a database for storing the storytelling script and answers to questions posed from the digital character to the user.

11. The system of claim 10 wherein the dialog type comprises one of the following:
a. dialog with no question for the user;
b. question awaiting a Yes or No response from the user;
c. question awaiting a pre-defined binary response from the user other than Yes or No;
d. question awaiting any response from the user; and
e. end of episode or story.

12. The system of claim 11 wherein the stored user answers are referenced later in a same story or future stories.

13. The system of claim 12 wherein the digital characters speak using synthetic voices based on text-to-speech conversion by the speech output converter.

14. The system of claim 13 wherein the storytelling script does not change regardless of the answer of the user to a question from the digital character.

15. The system of claim 14 wherein the storytelling script specifies at least the following:
a. which digital character should be speaking;
b. when dialog hand-offs should occur from one digital character to another;
c. which digital character should ask the user a question;
d. what response from the digital character should be provided based on spoken input of the user; and
e. which digital character should speak after the user responds to a question and what the response from the digital character should be.

16. The system of claim 15 wherein the system is implemented as an app on a smart speaker device.
